(19) United States
(12) Patent Application Publication
(10) Pub. No.: US 2013/0054848 A1
(43) Pub. Date: Feb. 28, 2013

(54) VIDEO GRAPHIC ARRAY CABLE WITH INDICATOR AND KEYBOARD, VIDEO, MOUSE SWITCH SYSTEM

(71) Applicant: YU-CHENG HUANG, Tu-Cheng (TW)

(72) Inventor: YU-CHENG HUANG, Tu-Cheng (TW)

(73) Assignee: HON HAI PRECISION INDUSTRY CO., LTD., Tu-Cheng (TW)

(21) Appl. No.: 13/404,012

(22) Filed: Feb. 24, 2012

(30) Foreign Application Priority Data
Aug. 31, 2011 (TW) 100131399

(51) Int. Cl. G06F 13/38; H01R 3/00

(52) U.S. Cl. 710/72; 439/488

(57) ABSTRACT

A video graphic array cable includes a first video graphic array plug connector, a second video graphic array plug connector, a wire electrically connected between the first video graphic array plug connector and the second video graphic array connector, and an indicator. The first video graphic array plug connector includes an insulated main portion and fifteen contact terminals accommodated in the main portion. The contact terminals include a power terminal connectable to a power source and a ground terminal. The indicator is electrically connected between the power terminal and the ground terminal.

### BACKGROUND

1. Technical Field

The present disclosure relates to keyboard, video, mouse (KVM) switch systems and, particularly, to a video graphic array (VGA) cable having an indicator and a KVM switch system using the VGA cable.

2. Description of Related Art

KVM switches are used to connect multiple computers, a keyboard, a display device, and a mouse. A KVM switch usually includes a number of selection switches. Each computer is electrically connected to the KVM switch via a VGA cable. Each selection switch controls a computer through a VGA cable. In use, when a user turns on one selection switch, the corresponding computer is communicated with the keyboard, the display device, and the mouse. However, the user usually cannot readily determine which computer has been connected to this way.

Therefore, it is desirable to provide a disclosure, which can overcome the limitations described above.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a schematic view of a KVM switch system according to an exemplary embodiment.

FIG. 2 is a back view of a KVM switch of the KVM switch system of FIG. 1.

FIG. 3 is a front view of a VGA cable of the KVM switch system of FIG. 1.

FIG. 4 is a partial circuit diagram of the KVM system of FIG. 1.

### DETAILED DESCRIPTION

Embodiments of the present disclosure will now be described in detail with reference to the drawings.

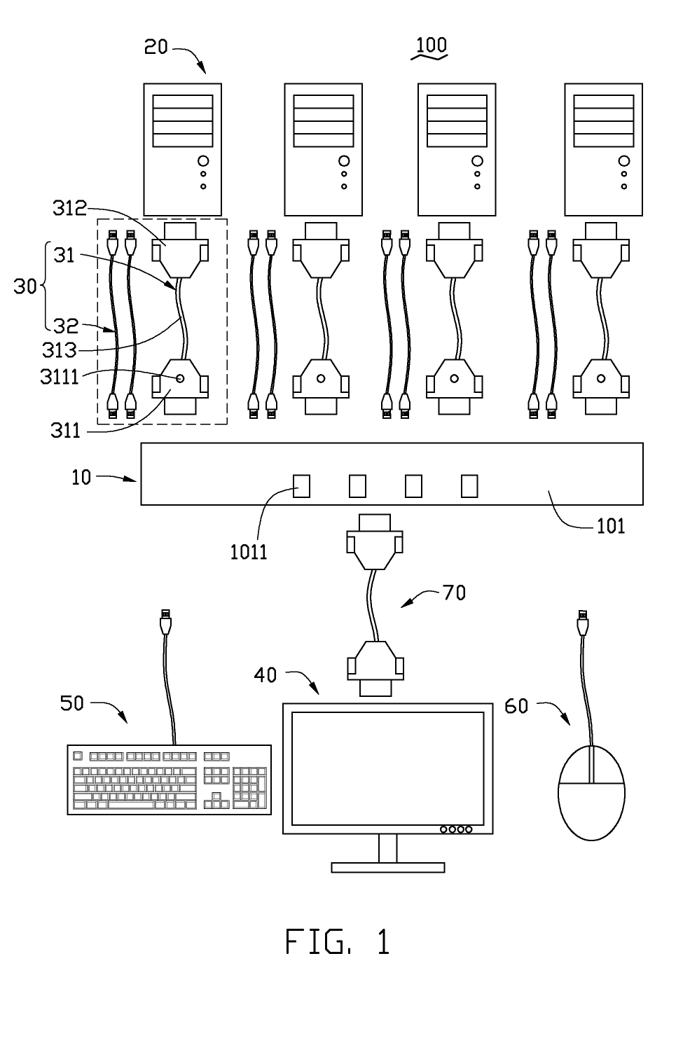

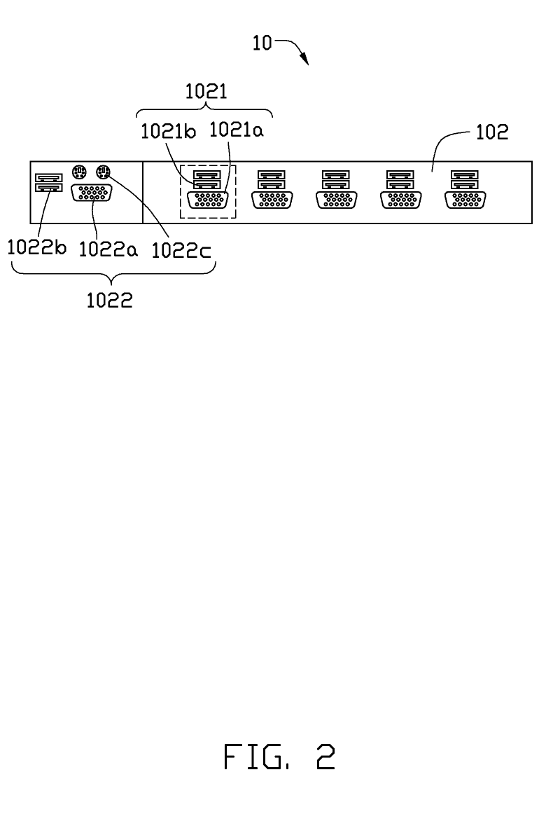

Referring to FIGS. 1 and 2, a KVM switch system 100, according to an exemplary embodiment, is shown. The KVM switch system 100 includes a KVM switch 10, a number of computers 20, a number of guest cable assemblies 30, a display device 40, a keyboard 50, a mouse 60, and a VGA cable 70. As an example, four computers 20 and four guest cable assemblies 30 are shown in FIG. 1; however, the number of the computers 20 and the guest cable assemblies 30 are not limited to four.

The KVM switch 10 is configured to connect the computers 20 to the display device 40, the keyboard 50, and the mouse 60. The KVM switch 10 includes a front surface 101, a rear surface 102 opposite to the front surface 101, a number of selection switches 1011, a number of guest connection port units 1021, and a host connection port unit 1022. The selection switches 1011 are mounted on the front surface 101. The guest connection port units 1021 and the host connection port unit 1022 are disposed at the rear surface 102. Each guest connection port unit 1021 can be activated or inactivated by turning on or off a corresponding selection switch 1011 and include a first VGA socket connector 1021a and two first universal serial bus (USB) socket connectors 1021b. The host connection port unit 1022 includes a second VGA socket connector 1022a, two second USB socket connectors 1022b, and two personal system/2 (PS/2) socket connectors 1022c.

Each computer 20 is connected to the KVM switch 10 through a corresponding guest cable assembly 30. Each guest cable assembly 30 includes a VGA cable 31 and two USB cables 32. Each VGA cable 31 includes a first VGA plug connector 311, a second VGA plug connector 312, a wire 313 electrically connected between the first VGA plug connector 311 and the second VGA connector 312, and an indicator 3111. The first VGA plug connector 311 and the second VGA plug connector 312 are electrically connected to the first VGA socket connector 1021a of the corresponding guest connection port unit 1021 and the corresponding computer 20, respectively. Each USB cable 32 is electrically connected between the first USB socket connector 1021b of the corresponding guest connection port unit 1021 and the corresponding computer 20.

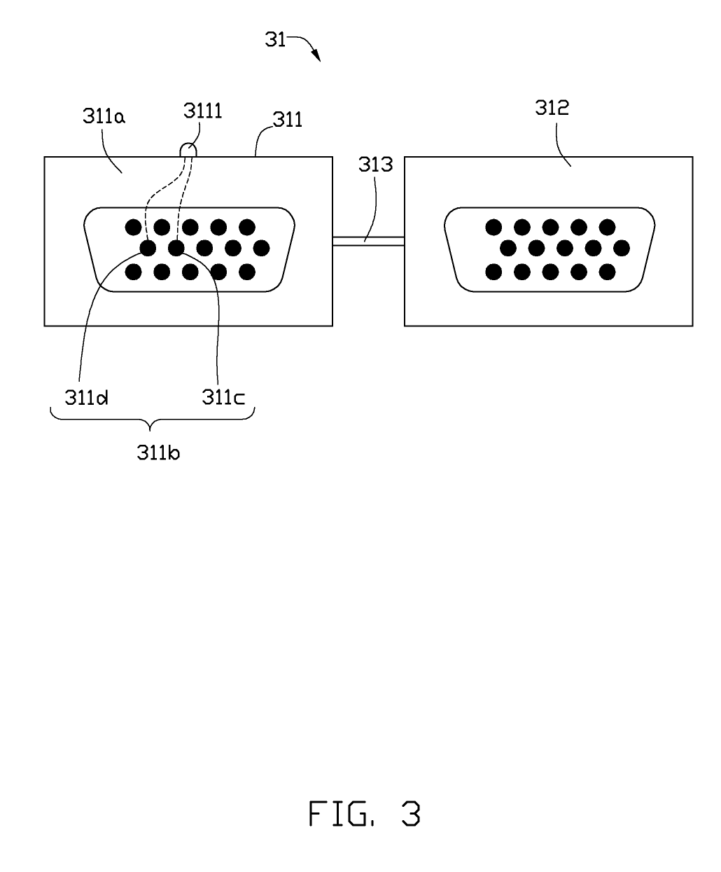

Referring to FIG. 3, each first VGA plug connector 311 includes an insulated main portion 311a and fifteen contact terminals 311b accommodated in the main portion 311a. The fifteen contact terminals 311b are arranged in three columns and each column includes five contact terminals 311b. The contact terminals 311b include a power terminal 311c and a ground terminal 311d in a middle column of the three columns. The indicator 3111 is electrically connected between the power terminal 311c and the ground terminal 311d. The indicator 3111 is mounted on the exterior surface of the main portion 3111a.

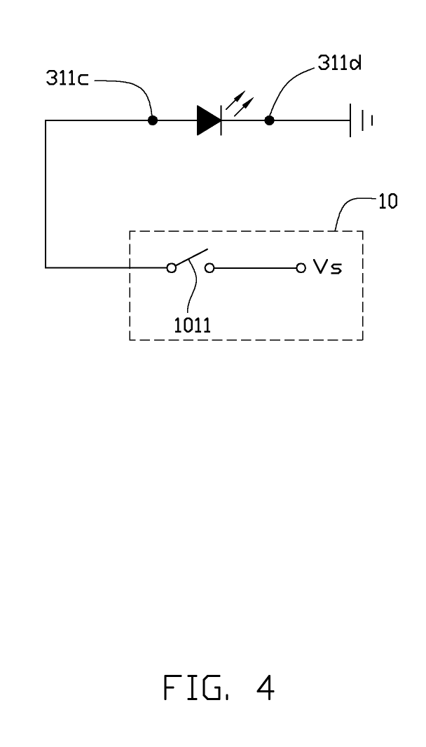

Referring to FIG. 4, when each first VGA plug connector 311 is connected to a first VGA socket connector 1021a. The power terminal 311 is connected to a direct current (DC) power source Vs of the KVM switch 10 through a corresponding selection switch 1011. The ground terminal 311d is grounded. In this embodiment, the indicator 3111 is a light emitting diode (LED) capable of emitting green light. The power source Vs can supply about 5 volts.

The display device 40 is connected to the second VGA socket connector 1022a through the VGA cable 70. Each of the keyboard 50 and the mouse 60 includes a USB plug connector (not labeled) and is connected to a second USB socket connector 1022b, respectively. In alterative embodiments, each of the keyboard 50 and the mouse can include a PS/2 plug connector (not shown) and is connected to a PS/2 socket connector 1022c, respectively.

Referring to FIGS. 1, 2, and 4, in use, the four computers 20 are all powered on, each of the computers 20 is connected to the corresponding guest connection port unit 1021 through the corresponding guest cable assembly 30. Each guest connection port unit 1021 corresponds to a selection switch 1011. Therefore, each computer 20 can be switched on and off by a selection switch 1011 through the corresponding VGA cable 31. When a user turns on one of the selection switches 1011, the corresponding computer 30 is connected to the KVM switch 10 and thus can transmit image signals to the display device 40 through the KVM switch 10 and can be controlled by the keyboard 50 and the mouse 60. The corresponding indicator 3111 is powered on and emits light. Therefore, it is easy for the user to tell which computer is being used.

When the corresponding selection switch 1011 is turned off, the computer 30 is disconnected from the KVM switch 10 and the corresponding indicator 3111 is off. Of course, only one of the selection switches 1011 is allowed to be turned on at a time. When one of the selection switches 1011 is turned on, the remaining selection switches 1011 remain off or are automatically turned off.

In alterative embodiments, the indicator 3111 can be mounted on the exterior surface of the wire 313 of each improved VGA cable 31 or on the exterior surface of the second VGA plug connector 312 of each improved VGA cable 31.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. An video graphic array cable, comprising:
a first video graphic array plug connector;
a second video graphic array plug connector;
a wire electrically connected between the first video graphic array plug connector and the second video graphic array connector; and
an indicator;
wherein the first video graphic array plug connector comprising an insulated main portion and fifteen contact terminals accommodated in the main portion, the contact terminals comprises a power terminal connectable to a power source and a ground terminal; the indicator is electrically connected between the power terminal and the ground terminal.

2. The video graphic array cable of claim 1, wherein the fifteen contact terminals are arranged in three columns having five contact terminals each, the power terminal and the ground terminal terminals are in a second column of the three columns.

3. The video graphic array cable of claim 1, wherein the indicator is mounted on an exterior surface of the wire.

4. The video graphic array cable of claim 1, wherein the indicator is mounted on an exterior surface of the second video graphic plug connector.

5. The video graphic array cable of claim 1, wherein the indicator is a light emitting diode.

6. A keyboard, video, mouse switch system, comprising:
a keyboard, video, mouse switch for connecting a number of computers, a display device, and a mouse, the keyboard, video, mouse switch system and comprising:
a number of selection switches; and
a number of guest connection port units, each guest connection port unit configured to be activated or inactivated by turning on or off a corresponding selection switch; and
a number of guest cable assemblies, each computer connected to the keyboard, video, mouse switch through a corresponding guest cable assembly;
wherein each guest cable assembly comprises an video graphic array cable, the video graphic array cable comprises a first video graphic array plug connector connected to a corresponding guest connection port unit, a second video graphic array plug connector connected to a corresponding computer, a wire electrically connected between the first video graphic array plug connector and the second video graphic array connector, and an indicator; the first video graphic array plug connector comprises an insulated main portion and fifteen contact terminals accommodated in the main portion, the contact terminals comprises a power terminal connectable to a power source and a ground terminal; the indicator is electrically connected between the power terminal and the ground terminal; when one of the selection switches is turned on, the corresponding guest connection port unit is activated and the indicator of the video graphic array cable corresponding to the turned on selection switch is power on and emits light.

7. The keyboard, video, mouse switch system of claim 6, wherein each guest connection port unit comprises a first video graphic array socket connector, the first video graphic array plug connector of each video graphic array cable is connected to the first video graphic array socket connector.

8. The keyboard, video, mouse switch system of claim 6, wherein each guest connection port unit further comprises two first universal serial bus socket connectors; each guest cable assembly further comprises two universal serial bus cables, each of the universal serial bus cables is connected between the corresponding computer and a first universal serial bus socket connector.

9. The keyboard, video, mouse switch system of claim 6, wherein the keyboard, video, mouse switch further comprises a host connection port unit, the host connection port unit comprises a second video graphic array socket connector and two second universal serial bus socket connectors, each of the keyboard and the mouse is connected to a second universal serial bus socket connectors.

10. The keyboard, video, mouse switch system of claim 6, wherein the power terminal is connected to the power source through a corresponding selection switch.

11. The keyboard, video, mouse switch system of claim 6, wherein the fifteen contact terminals are arranged in three columns and having five contact terminals each, the power terminal and the ground terminal terminals are in a second column of the three columns.

12. The keyboard, video, mouse switch system of claim 6, wherein the indicator is mounted on an exterior surface of the wire.

13. The keyboard, video, mouse switch system of claim 6, wherein the indicator is mounted on an exterior surface of the second video graphic plug connector.

14. The keyboard, video, mouse switch system of claim 6, wherein the indicator is a light emitting diode.
